(19) United States
(12) Patent Application Publication
(10) Pub. No.: US 2014/0022784 A1
(43) Pub. Date: Jan. 23, 2014

(54) LED LAMP COMPRISING AN LED AS THE LUMINAIRE AND A GLASS OR PLASTIC LAMPSHADE

(71) Applicants: Alexander Dohn, Memmelsdorf (DE); Roland Leneis, Marktredwitz (DE); Alfred Thimm, Wunsiedel (DE)

(72) Inventors: Alexander Dohn, Memmelsdorf (DE); Roland Leneis, Marktredwitz (DE); Alfred Thimm, Wunsiedel (DE)

(73) Assignee: Ceram Tec GmbH, Plochingen (DE)

(21) Appl. No.: 14/008,850

(22) PCT Filed: Mar. 30, 2012
(86) PCT No.: PCT/EP12/55745

§ 371 Date: Oct. 1, 2013

(30) Foreign Application Priority Data
Apr. 4, 2011 (DE) 102011006724.8

(51) Int. Cl. F21V 3/04

(52) U.S. Cl. CPC F21V 3/0427; F21V 3/0445; F21V 3/0481
USPC 362/235

(57) ABSTRACT

The invention relates to an LED lamp comprising at least one LED as the luminaire, a ceramic base and a ceramic supporting body, arranged on the base and having a supporting surface for accommodating the LEDs, and further comprising a light-permeable lampshade which is fixed on the supporting body and put on the supporting surface, sintered metalized sections, which form a circuit board, being arranged on the supporting surface for the LEDs to be soldered to and optionally for applying a corresponding circuit thereto. In order for the light emitted by the LEDs to be influenced and guided by simple means, the lampshade has a cupola, dome or bonnet design and consists of glass or plastic.

The invention relates to an LED lamp according to the preamble of the claim 1.

In the non-prepublished DE 10 2010 047 030 A1, an LED lamp having at least one LED as the luminaire is described. The lamp consists of a ceramic base and a ceramic supporting body that is arranged on the base and has a supporting surface for accommodating the LEDs. For this, sintered metallization regions, which form a circuit board, are arranged on the supporting surface. The metallization regions serve for soldering on the LEDs, optionally together with the associated circuit. Due to the fact that the metallization regions are sintered, extremely good heat dissipation from the LEDs into the ceramic of the supporting body is ensured. The supporting surface of the supporting body on which the LEDs are arranged is covered by a translucent lampshade.

It is an object of the invention to improve an LED lamp according to the preamble of the claim 1 in such a manner that the emitted light of the LEDs can be influenced and guided by simple means.

According to the invention, this object is achieved in that the lampshade is formed as a cupola, dome or bonnet and consists of glass or plastic. Such a cupola, dome or bonnet is able by simple means to guide and influence the light produced by the LEDs.

In one embodiment of the invention, the lampshade's region adjoining the supporting body is formed cylindrically and this regions transitions integrally into a spherical cover. Through this, the spherical cover is slightly farther away from the LEDs so that the focus is shifted outward.

Preferably, the inner surface of the lampshade is provided with a light-active layer that changes the color of the emitted light of the LEDs. Through this, any desired color can be set.

In one embodiment, the supporting surface of the supporting body is formed convex or concave, whereby the emitted light is scattered or bundled.

In one embodiment, the base and the supporting body are formed integrally, whereby the heat transport from the LEDs via the metallization regions into the ceramic of the supporting body and the base is enhanced.

In another embodiment, the base and the supporting body are formed as two pieces, the supporting body consisting of a ceramic having an identical or better thermal conductivity than the ceramic of the base, and the supporting body being connected to the base in a thermally conductive manner. Thus, the ceramic of the supporting body can be selected to be different from the ceramic of the base. Through the thermally conductive connection of the supporting body to the base, the heat to be dissipated reaches the base. The base can comprise cooling ribs on its outer surface.

For improving the heat dissipation, the supporting body can consist of highly thermally conductive aluminum nitride AIN.

Preferably, the base consists of aluminum oxide or aluminum nitride. In a simpler embodiment, the supporting body and the base consist of aluminum oxide.

Preferably, the electrical connecting wires are fed through a cavity in the base up to the supporting body and are electrically connected there to the sintered metallization regions which form a circuit board, or are directly connected to the LEDs. In this manner, the connecting wires are arranged protected in the base.

On the lower front side of the base, a socket such as an E27 or a plug such as a GU10 can be arranged. This facilitates mounting.

The invention is further explained below with reference to four figures.

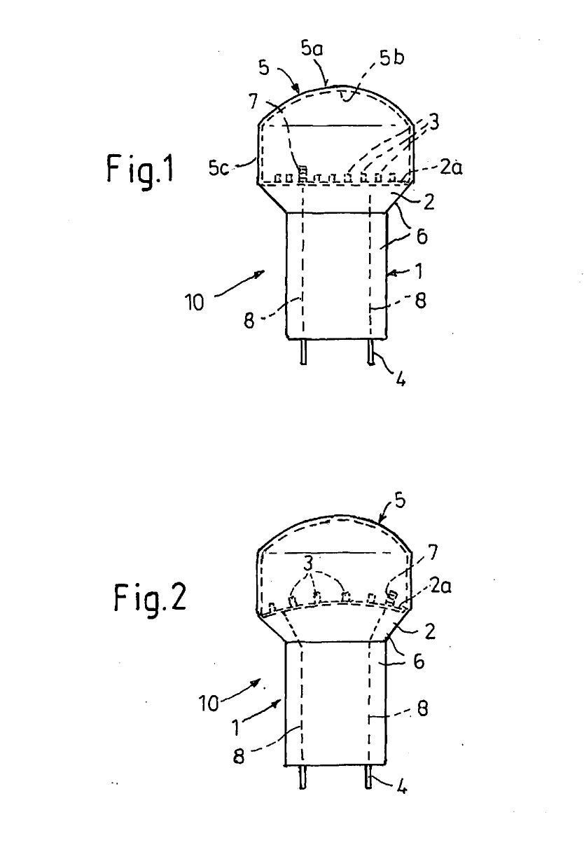

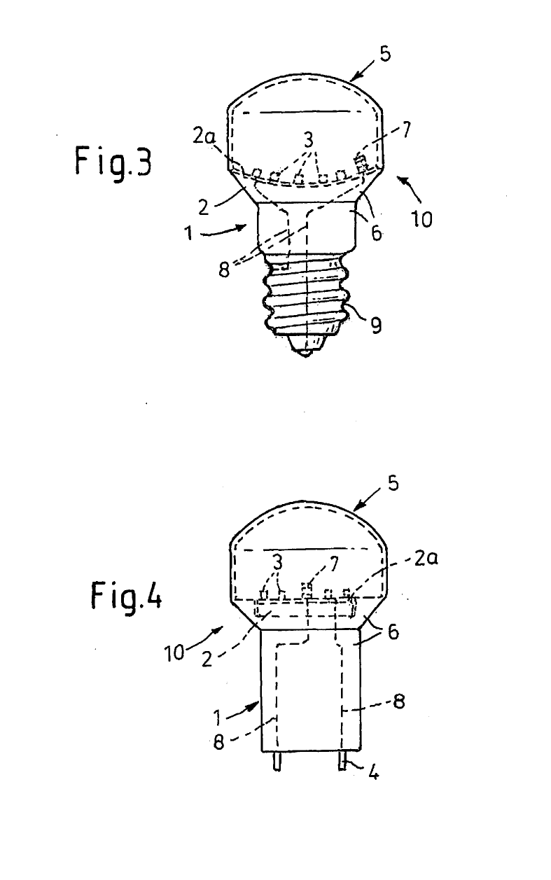

FIG. 1 shows one embodiment of an LED lamp 10 according to the invention. The lamp 10 consists of a monobloc or one-piece ceramic base support 6 which, at the same time, is socket or base 1 and supporting body 2 of the LEDs 3 including the required electric/electronic circuit 7. The surface of the supporting body 2 forms a supporting surface 2a on which the LEDs are arranged. The ceramic base support 6 (e.g. from aluminum oxide or aluminum nitride) can be a traditional socket (light bulb socket see FIG. 3) or a socket such as an E27, or a plug-in socket or plug 4 (see FIG. 2 or 4) such as a GU10. From here, the electrical connecting wires 8 are fed upward up to the LEDs 3. The base support 6 can also be designed as two pieces comprising a base 1 and a supporting body 2 which is arranged thereon and has a supporting surface 2a on which the LEDs 3 and optionally the circuit 7 are arranged.

In the embodiment of an LED lamp 10 shown in FIG. 1 in which the lamp body consists of a one-piece ceramic base support 6, the supporting surface 2a of the supporting body 2, on which the LEDs 3 and the circuit 7 are applied, is formed planar or flat.

The one-piece ceramic base support 6 can also be hollow. If needed, drivers for any LEDs 3 can be accommodated in the cavity. On the outer side of the base 1, cooling ribs can be arranged.

A lampshade 5, in the present case a glass cupola or glass dome or a glass bonnet, is put over the supporting body 2 with its supporting surface 2a and is preferably fixed by soldering or glueing. The supporting body 2 is also described as a ceramic LED platform. This lampshade 5 or glass dome, one the one hand, protects the LEDs 3, is able to guide the light (e.g., widen the light cone) and, if needed, can also change the color of the light by light-active materials or layers applied thereon and thus can generate a more pleasant light tone (principle of fluorescent tubes).

The lampshade's 5 region 5c adjoining the supporting body 2 is preferably formed cylindrically, as shown in the FIGS. 1-4, and this region 5c transitions integrally into a spherical cover 5a.

The inner surface 5b of the lampshade 5 is preferably provided with a light-active layer which changes the color of the emitted light of the LEDs 3.

An important feature of the invention is that the base support 2 is configured as a circuit board. This is achieved in that sintered metallization regions are applied onto the supporting surface 2a of the supporting body 2. To this, reference is made to WO 2007107601 A2 where this is described. The LEDs 3 and the circuit 7 can be soldered directly onto these metallization regions. The advantage of this is, among other things, that due to the high thermal conductivity, the heat produced by the LEDs 3 is dissipated directly into the ceramic of the supporting body 2.

FIG. 2 and FIG. 3 show alternative embodiments of the invention which differ from the embodiment according to FIG. 1 in that the supporting surface 2a of the supporting body 2 are formed convex (FIG. 2) or concave (FIG. 3). Through this, the emitted light is scattered or bundled. FIG. 2 shows a plug 4 GU10 and FIG. 3 shows a socket 9 such as an E27. Apart from that, the embodiments according to FIGS. 2 and 3 are identical to that of FIG. 1.

The upper end of the ceramic base support 1, i.e., the supporting surface 2a of the supporting body 2 for the LEDs 3, and the circuit 7 can be formed as a flat (FIG. 1) or curved (convex, FIG. 2) or concave (FIG. 3) supporting body 2, which is preferably round on the outside, for the (one or more) LEDs 3 which can be soldered here onto a usual thick film metallization such as Ag or AgPt. In addition, there is also room for series resistors which are printed using thick film technology or are soldered on as SMT resistors. The supporting body 2 with its supporting surface 2a for accommodating the LEDs 3 and the circuit 7 can also be formed as a disc-shaped one-piece component (see FIG. 4) which is connected to the base 1 in a thermally conductive manner. This supporting body 2 is then preferably a supporting disc and can be produced, e.g., from a more expensive ceramic material such as AIN for better thermal conductivity, whereas the base 1 can consist of an inexpensive ceramic such as Al₂O₃. In this case, the thermal conductivity of the supporting body 2 would be higher than the thermal conductivity of the base 1. FIG. 4 shows as an example a plug 4 GU10.

On suitable conducting path structures (sintered metallizations on the supporting surface 2a), certain LEDs 3 can also be connected directly to the 220-230V AC grid of the building. For this, they no longer need drivers; both amplitudes (+/−) make the diodes or LEDs 3 to light up. Of course, other LEDs 3, in this case with drivers as the circuit, can also be installed.

As already described in connection with FIG. 1, a lampshade 5 or glass cupola (glass dome) is put over the ceramic LED platform or the supporting body 2 and is fixed on the supporting body by soldering or glueing. This lampshade 5, one the one hand, protects the LEDs 3, is able to guide the light (e.g., widen the light cone) and, if needed, can also change the color of the light by light-active materials or layers applied thereon, and thus can generate a more pleasant light tone (principle of fluorescent tubes).

The supporting body 2 with its supporting surface 2a, and the base 1 either as a one-piece base support 6 (FIGS. 1, 2, 3) or as separate components (FIG. 4) principally represent a special ceramic cooling body. Through the sintered metallizations on the supporting surfaces 2a, a circuit board is provided that is the support of the LEDs 3 and the circuit 7.

Due to the selection of the ceramic materials, extremely high thermal conductivity can be obtained so that the lamp according to the invention, on the one hand, can be produced in a simple manner and, on the other, has a long service life since the heat produced by the LEDs is dissipated.

In an alternative embodiment for all variants of the lamp according to the invention, the lampshade 5, instead of glass, could consist of special translucent plastics which, for example, filter out a light color such as ultraviolet or blue without a conversion layer, at the expense of a lower light output. With the generally better permeable and coated glasses, undesirable light colors can be converted while obtaining a similar total light output.

In the embodiment comprising a separate supporting body 2 and a separate base 1, both made from ceramics, the base 1 can also be formed hollow. In the cavity, drivers for any LEDs 3 could be accommodated, if needed. On the outer side of the base 1, cooling ribs can be arranged. Likewise, the one-piece or monobloc base support 6 can be formed hollow so as to accommodate drivers for any LEDs 3, if needed.

1.-10. (canceled)

11. An LED lamp comprising:
a light emitting diode (LED) as the luminaire;
a ceramic base;
a ceramic supporting body that is arranged on the ceramic base and has a supporting surface for accommodating the LED,
a translucent lampshade comprising at least one member selected from the group consisting of glass and plastic, wherein the translucent lampshade is fixed on the supporting body and put over the supporting surface; and
sintered metallization regions which form a circuit board, being arranged on the supporting surface for soldering on the LED;
wherein the translucent lampshade is formed as a member selected from the group consisting of cupola, dome and bonnet.

12. The lamp according to claim 11, wherein a lampshade comprises a region adjoining the supporting body which is formed cylindrically, and wherein said region transitions integrally into a spherical cover.

13. The lamp according to claim 11, wherein an inner surface of the lampshade is provided with a light-active layer that changes a color of the emitted light of the LED.

14. The lamp according to claim 11, wherein the supporting surface of the supporting body is formed convex or concave.

15. The lamp according to claim 11, wherein the base and the supporting body are formed as one piece.

16. The lamp according to claim 11, wherein the base and the supporting body are formed as two pieces;
wherein the supporting body consisting of a ceramic having an identical or better thermal conductivity than the ceramic of the base; and
wherein the supporting body is connected to the base in a thermally conductive manner.

17. The lamp according to claim 11, wherein the supporting body comprises thermally conductive aluminum nitride.

18. The lamp according to claim 11, wherein the base comprises at least one member selected from the group consisting of aluminum oxide and aluminum nitride.

19. The lamp according to claim 11, wherein electrical connecting wires are fed through a cavity in the base up to the supporting body and are electrically connected to the sintered metallization region or are directly connected to the LED.

20. The lamp according to claim 11, wherein on a lower front side of the base at least member selected from the group consisting of a socket and a plug is arranged.

21. The lamp according to claim 12, wherein an inner surface of the lampshade is provided with a light-active layer that changes a color of the emitted light of the LED.

22. The lamp according to claim 12, wherein the supporting surface of the supporting body is formed convex or concave.

23. The lamp according to claim 12, wherein the base and the supporting body are formed as one piece.

24. The lamp according to claim 12, wherein the base and the supporting body are formed as two pieces;
wherein the supporting body consisting of a ceramic having an identical or better thermal conductivity than the ceramic of the base; and
wherein the supporting body is connected to the base in a thermally conductive manner.

25. The lamp according to claim 12, wherein the supporting body comprises thermally conductive aluminum nitride.

26. The lamp according to claim 12, wherein the base comprises at least one member selected from the group consisting of aluminum oxide and aluminum nitride.

27. The lamp according to claim 12, wherein electrical connecting wires are fed through a cavity in the base up to the supporting body and are electrically connected to the sintered metallization region or are directly connected to the LED.

28. The lamp according to claim 12, wherein on a lower front side of the base at least member selected from the group consisting of a socket and a plug is arranged.

29. The lamp according to claim 13, wherein the supporting surface of the supporting body is formed convex or concave.

30. The lamp according to claim 13, wherein electrical connecting wires are fed through a cavity in the base up to the supporting body and are electrically connected to the sintered metallization region or are directly connected to the LED.
